(19) United States
(12) Patent Application Publication
(10) Pub. No.: US 2010/0034988 A1
(43) Pub. Date: Feb. 11, 2010

(54) Brightness enhancement film of backlight module

(75) Inventors: Lung-Shiang Luh, Suzhou (CN); Ching-Hua Ting, Suzhou (CN)

Correspondence Address: BACON & THOMAS, PLLC, 625 SLATERS LANE, FOURTH FLOOR, ALEXANDRIA, VA, 22314-1176, US

(73) Assignee: Core-Flex Optical (Suzhou) Co., Ltd, Suzhou (CN)

(21) Appl. No.: 12/461,042

(22) Filed: Jul. 30, 2009

(30) Foreign Application Priority Data
Aug. 6, 2008 (TW) 097129890

(51) Int. Cl. C09K 19/02

(52) U.S. Cl. 428/1.1

(57) ABSTRACT

A brightness enhancement film of a backlight module includes a substrate and a plurality of microstructure units. The substrate has an edge having an extension direction. The microstructure units are jointed on a surface of the substrate with the junction areas. The junction areas have different extension directions and different extension lengths. The extension directions and extension lengths of the junction areas are combined to form a resultant vector. An included angle is formed between a direction of the resultant vector and the extension direction of the edge of the substrate, and a range of the included angle is from negative 45 degree to positive 45 degree.

### BACKGROUND OF THE INVENTION

(1) Field of the Invention

The invention relates to a brightness enhancement film, and more particularly relates to a brightness enhancement film of a backlight module.

(2) Description of the Related Art

A backlight module applied in a liquid crystal display (LCD) includes a plurality of different optical films, and among the optical films the main one is prism sheet, also called brightness enhancement film.

Refer to FIG. 1 for a schematic view of a conventional brightness enhancement film 100a. The conventional brightness enhancement film 100a has a plurality of linear microstructures 120a disposed on surface of the conventional brightness enhancement film 100a to concentrate light and enhance brightness of the backlight module.

FIG. 2 shows fabrication process of the conventional brightness enhancement film 100a. The microstructures 120a are fabricated on a master slide 100 at beginning. Then the master slide 100 is cut into a plurality of conventional brightness enhancement films 100a. Real line frame in FIG. 2 represents brim of the conventional brightness enhancement film 100a, and real line strip represents crest line. Long edge of the real line frame is parallel to the extension direction of the microstructures 120 on the master slide 100. Thus the linear microstructures 120a on the surface of the brightness enhancement film 100a fabricated in above way are parallel to the long edge of the brightness enhancement film 100a.

The microstructures 120a of the conventional brightness enhancement film 100a and the pixels of a liquid crystal panel (not shown) are both regularly arranged, when the conventional brightness enhancement film 100a and the liquid crystal panel are overlapped in assembly, if the extension direction of the microstructures 120a of the conventional brightness enhancement film 100a is consistent with the arrangement direction of the pixels of the liquid crystal panel, and the size of a single pixel of the liquid crystal panel does not match the distance between the microstructures 120a of the conventional brightness enhancement film 100a, optical interference fringe called ‘pixel moiré phenomenon’ occurs easily. When pixel moiré phenomenon occurs, clear strips and abnormal color appear in the LCD image, and the clear strips and the abnormal color are unaccepted by customers.

Referring to FIG. 3, generally the pixel moiré phenomenon is eliminated by rotating the cutting machine a certain angle a intentionally when producing the brightness enhancement film, and then cutting the master slide 100. In this way, the edge of the brightness enhancement film 100b intersects obliquely with the microstructures 120b. Thus, when the brightness enhancement film 100b and the liquid crystal panel are assembled in overlap, the extension direction of the microstructures 120b of the brightness enhancement film 100b also intersects obliquely with the arrangement direction of the pixels of the liquid crystal panel, and pixel moiré phenomenon is hard to be generated.

However, comparing FIG. 2 with FIG. 3, if using respectively the two methods to output the same number of the brightness enhancement films 100a and 100b, the cutting method in FIG. 3 needs the master slide 100 with larger area, and thus wastes margin of the master slide 100 remarkably and decreases effective output area of the brightness enhancement film 100b directly, going against cost control.

### SUMMARY OF THE INVENTION

The invention provides a brightness enhancement film of a backlight module for blurring the optical interference fringe.

A brightness enhancement film is provided in an embodiment of the invention. The brightness enhancement film includes a substrate and a plurality of microstructure units. The substrate has an side edge having an extension direction. The microstructure units are jointed on a surface of the substrate with a plurality of junction areas. The junction areas have different extension directions and different extension lengths, wherein the extension directions and the extension lengths of the junction areas are combined to form a resultant vector. An included angle is formed between the direction of the resultant vector and the extension direction of the edge of the substrate, and a range of the included angle is from negative 45 degree to positive 45 degree.

A brightness enhancement film is provided in another embodiment of the invention. The brightness enhancement film includes a substrate and a plurality of microstructure groups. The substrate has a side edge and a plurality of areas, wherein the side edge has an extension direction. The microstructure groups are disposed in the different areas of the substrate respectively. Each of the microstructure groups includes a plurality of microstructure units jointed in the same area of the substrate with a plurality of junction areas. The junction areas have different extension directions and different extension lengths, wherein the extension directions and the extension lengths of the junction areas in the same microstructure group are combined to form a resultant vector. An included angle is formed between the direction of the resultant vector and the extension direction of the edge of the substrate. A range of the included angle is from negative 45 degree to positive 45 degree.

In an embodiment of the invention, the microstructure units in each of the microstructure groups are configured in an arrangement, and the arrangements in the microstructure groups are all the same.

In an embodiment of the invention, each of the microstructure units is a long strip prism having a crest line and a bottom, and the bottom is used as one of the junction areas. The bottom is jointed on a surface of the substrate. At least one crest height is between the crest line and the bottom. The extension length of the bottom of the long strip prism ranges from 10 um to 10000 um, and the crest height ranges from 0 um to 100 um. The width of the bottom of the long strip prism has a maximum value ranging from 10 um to 100 um.

In an embodiment of the invention, each of the microstructure units further includes an crest line and two inclined surfaces. The two inclined surfaces extend upwards from two opposite sides of the junction area respectively and meet at the crest line to form an intersection angle. The junction area of each of the microstructure units is in the shape of a triangle, a leaf, a rectangle, or a round. The intersection angle of the two inclined surfaces of each of the microstructure units in the same microstructure group is different from each other. Each of the microstructure units has a round angle structure at the crest line.

The microstructure units of the brightness enhancement film in the embodiments have different extension directions and different extension lengths. Thus the brightness enhancement film has a better elimination effect on optical interference fringe, and when cutting the master slide, the influence of the direction of the microstructure units on the optical interference fringe is not considered. Thus the cutting angle is not limited, so that the utilization of the master slide is increased to further save cost.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic view of a conventional brightness enhancement film and microstructures of the conventional brightness enhancement film.

FIG. 2 is a schematic view showing a cutting method of a conventional brightness enhancement film.

FIG. 3 is a schematic view showing another cutting method of a conventional brightness enhancement film.

FIG. 4 is a schematic view showing an embodiment of a brightness enhancement film and microstructure units of the brightness enhancement film according to the invention.

FIG. 5 is a schematic view showing an embodiment of a brightness enhancement film and microstructure units of the brightness enhancement film according to the invention.

FIG. 6 is a schematic view showing microstructure units of an embodiment of a brightness enhancement film according to the invention.

FIG. 7A to FIG. 7D are stereogram views showing microstructure units of an embodiment of a brightness enhancement film according to the invention.

FIG. 8A to FIG. 8B are sectional views showing microstructure units of an embodiment of a brightness enhancement film according to the invention.

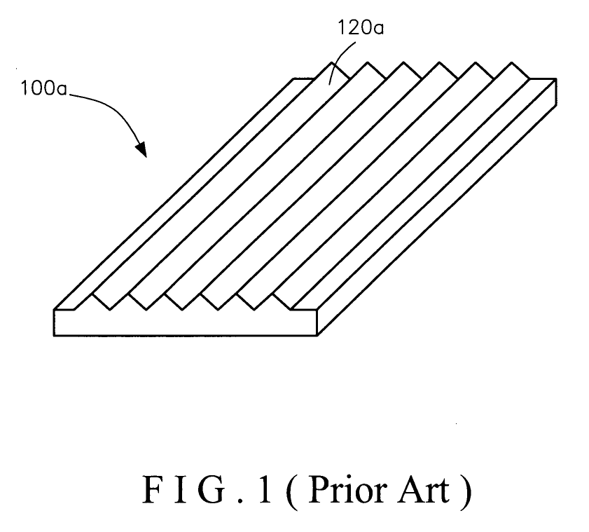

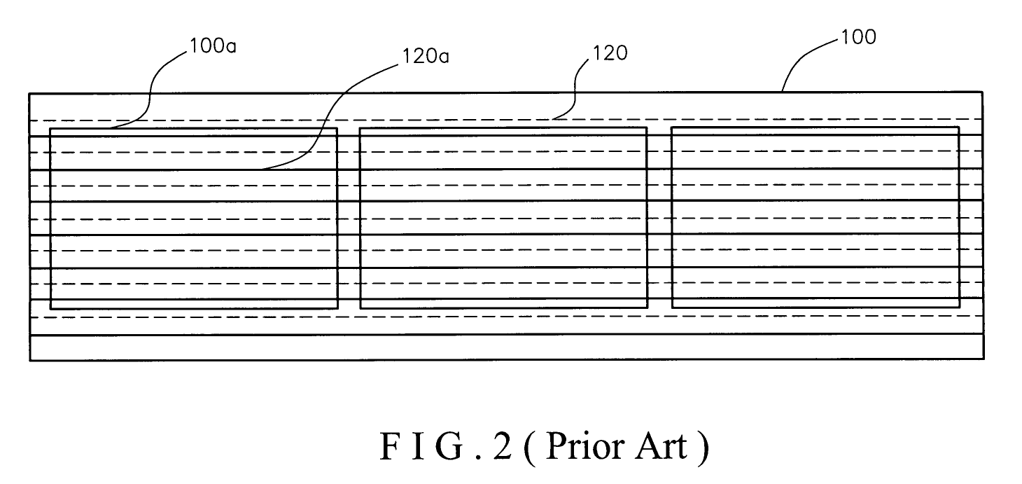

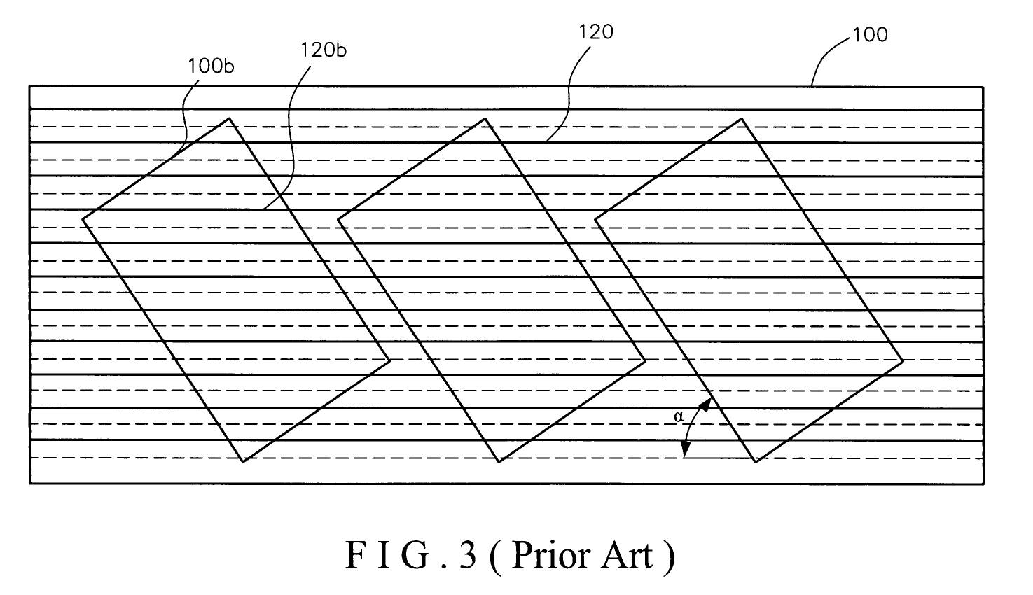

### DESCRIPTION OF THE PREFERABLE EMBODIMENTS

In the following detailed description of the preferable embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

Referring to FIG. 4, a brightness enhancement film 200 of a backlight module has a substrate 220 and a plurality of microstructure units 240a, 240b, 240c, . . . . The substrate 220 has a side edge 222 providing an extension direction V. A plurality of microstructure units 240a, 240b, 240c, . . . are jointed on a surface of the substrate 220 with the junction areas, and the junction areas have different extension directions Da, Db, Dc, . . . and different extension lengths La, Lb, Lc, . . . . The extension directions Da, Db, Dc, . . . and extension lengths La, Lb, Lc, . . . are combined to form a resultant vector S.

The resultant vector S represents an integrated direction of all microstructure units 240a, 240b, 240c, . . . . The resultant vector S is described by an equation: S=1/2(3 cos 2θ−1), where θ is an included angle between a direction of the resultant vector S and the extension direction V of the side edge 222 of the substrate 220. In an embodiment, a range of the included angle θ is from negative 45 degree to positive 45 degree, converted to 1>S>0.25 accordingly. In the range of the included angle θ, the microstructure units 240a, 240b, 240c, . . . are arranged in irregular directions but not too loose to affect density, so that both illumination performance and elimination of optical interferences may be considered.

In the present embodiment, the microstructure units 240a, 240b, 240c, . . . on the brightness enhancement film 200 are fabricated by molding, and the mold is produced by precise machining.

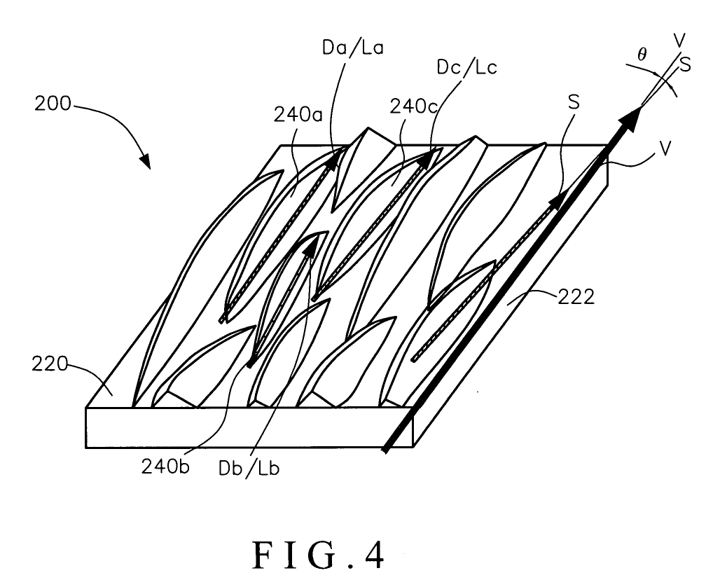

Referring to FIG. 5, a brightness enhancement film 300 in another embodiment of the invention has a substrate 320 and a plurality of microstructure groups 340. The substrate 320 has a side edge 322 and a plurality of areas 324. The side edge 322 provides an extension direction V. The microstructure groups 340 are disposed in different areas 324 of the substrate 320 respectively. Each of the microstructure groups 340 includes a plurality of microstructure units 340a, 340b, 340c, . . . .

All microstructure units 340a, 340b, 340c, . . . in the same microstructure group 340 are jointed in the same area 324 of the substrate 320 with junction areas. The junction areas have different extension directions Da, Db, Dc, . . . and different extension lengths La, Lb, Lc, . . . . The extension directions Da, Db, Dc, . . . and the extension lengths La, Lb, Lc, . . . in the same microstructure group 340 are combined to form a resultant vector S. In the present embodiment, the resultant vector S is an integrated direction of all the microstructure units 340a, 340b, 340c, . . . in the same area 324. Specifically, an included angle θ is formed between the direction of the resultant vector S and the extension direction V of the side edge 322 of the substrate 320. The range of the included angle θ is from negative 45 degree to positive 45 degree.

In the brightness enhancement film 300, the microstructure units 340a, 340b, 340c, . . . in each of the microstructure groups 340 are arranged as FIG. 5 shows, and the arrangements in all microstructure groups 340 are the same. For example, in FIG. 5 the area 324 inside the dashed line frame and the microstructure units 340a, 340b, 340c, . . . outside the dashed line frame have the same arrangement. Thus when producing the brightness enhancement film 300 with a larger area, the same mold may be used to press the same microstructure group 340 in different areas of the substrate 320 repeatedly.

Because the optical interference is caused by improper match of the size of the single pixel in the liquid crystal panel and the distances between the microstructure units 120a, the brightness enhancement film 300 in the embodiment has irregular microstructure units 340a, 340b, 340c, . . . , and the pixel moiré phenomenon is eliminated upon randomness of the extension directions Da, Db, Dc, . . . and difference of the extension lengths La, Lb, Lc, . . . or width or height. If the brightness enhancement films 200, 300 are coupled with the liquid crystal panel, the interference fringe becomes irregular and occur randomly and in whole appears a blurry state with no pixel moiré phenomenon.

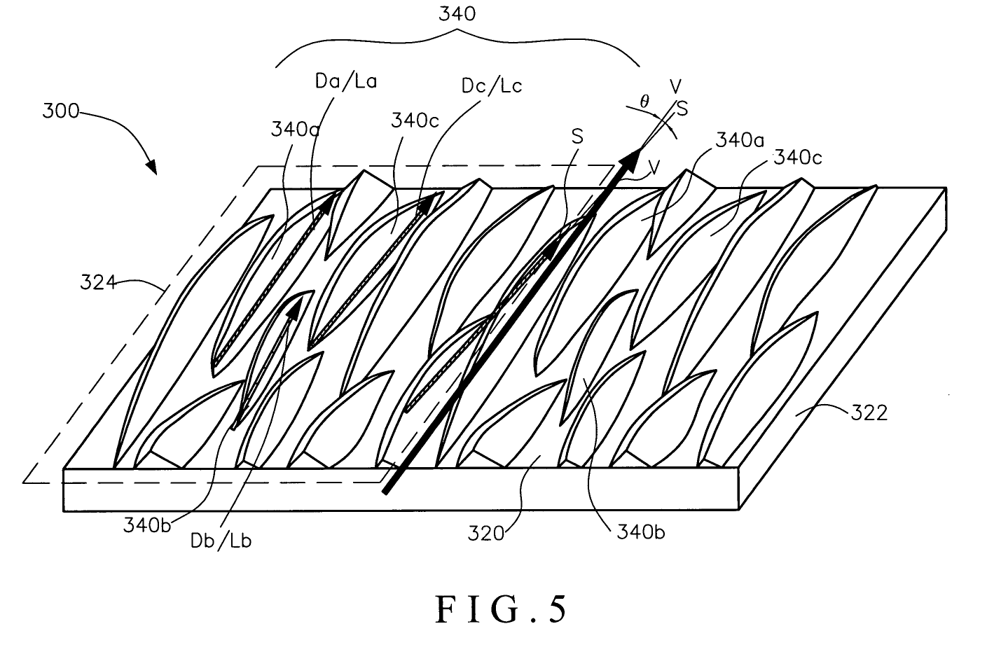

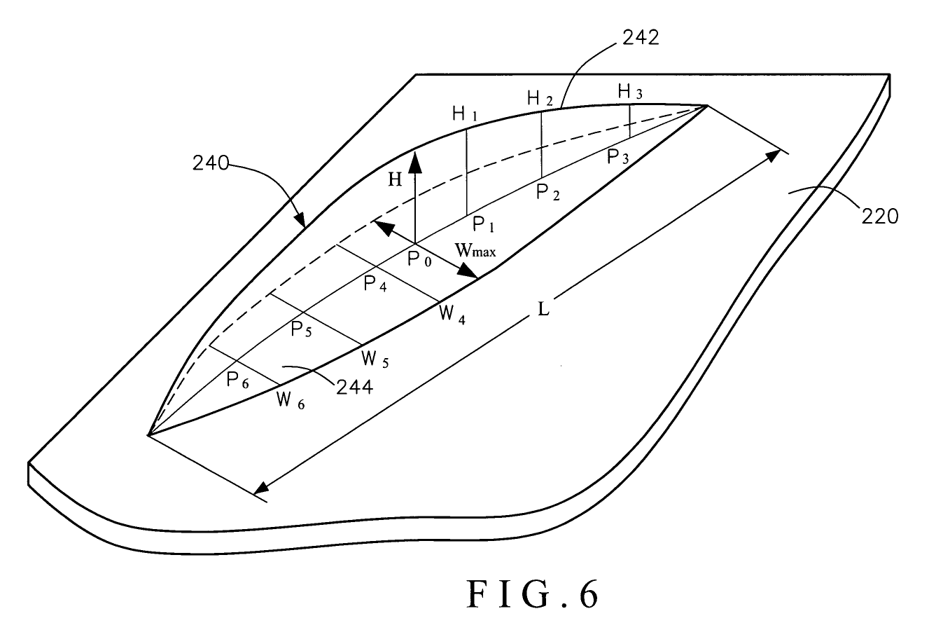

Referring to FIG. 4 and FIG. 6 at the same time, in an embodiment, each of the microstructure units 240a, 240b, 240c, . . . may be a long strip prim 240 with a crest line 242 and a bottom 244, and the bottom 244 is just the above-mentioned junction area. The bottom 244 of the long strip prism 240 is jointed on the surface of the substrate 220, and has at least a width Wmax, . . . , W4, W5 or W6. At least one crest height H, H1, H2 or H3, . . . is between the crest line 242 and the bottom 244. In the embodiment, different positions P0, P1, P2, P3,P4, P5, P6 within the extension length L of the bottom 244 of the long strip prism 240 correspond to different crest heights H, H1, H2, H3, . . . and different widths Wmax, . . . , W4, W5, W6. The range of the extension length L of the bottom 244 of the long strip prism 240 is from 10 um to 10000 um and the crest height H is from 0 um to 100 um. The range of Wmax of the bottom 244 is from 10 um to 100 um. In other words, the long strip prism 240 may appear different shapes like slight and long, thick and short, two ends sharp and middle wide. However, in other embodiments, different positions P0, P1, P2, P3,P4, P5, P6 in the extension length L of the bottom 244 of the long strip prism 240 may also correspond to the same crest height H, H1, H2, H3, . . . and the same width Wmax, . . . , W4, W5, W6.

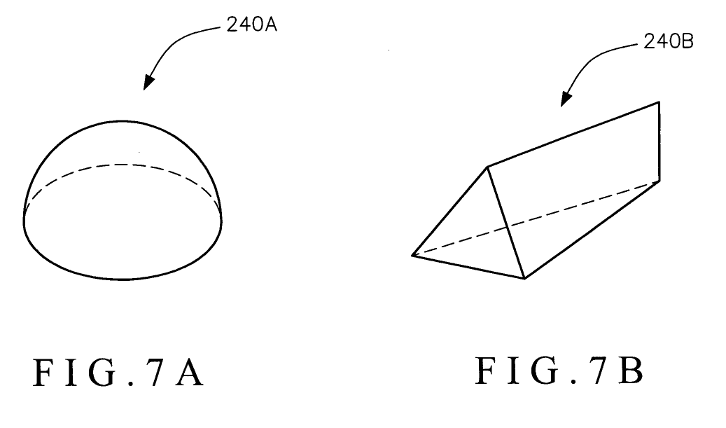

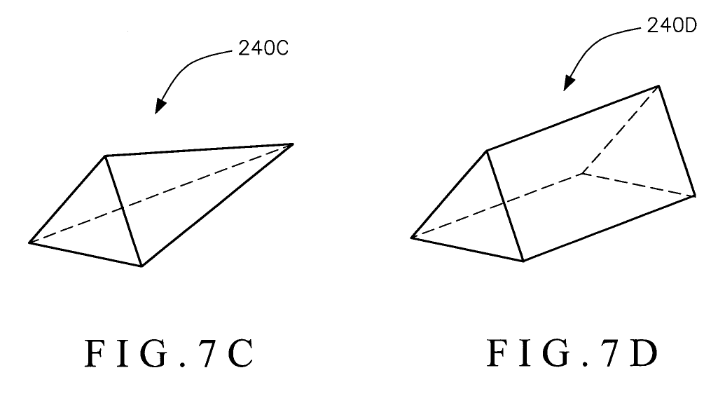

The long strip prism 240 in FIG. 6 has a bottom in the shape of a leaf. However, referring to FIG. 7A to 7D, in other embodiments of the invention, the bottom of the microstructure unit may be a triangle, a rectangle, a round or, an irregular shape. The microstructure unit 240A with a round bottom in FIG. 7A is a transformation of the long strip prism 240, the microstructure unit 240A is formed by shortening the extension length L of the bottom 244 of the long strip prism 240 to equaling to its width. The bottom of the microstructure unit 240B in FIG. 7B is a triangle. One end of the microstructure unit 240B is a triangle surface and the other is a sharp angle having a height unchangeable with the length. A microstructure unit 240C in FIG. 7C is a transformation of FIG. 7B, the height of the microstructure unit 240C goes small gradually with the length. A microstructure unit 240D in FIG. 7D is a common triangular prism, and may also be applied in the present embodiment.

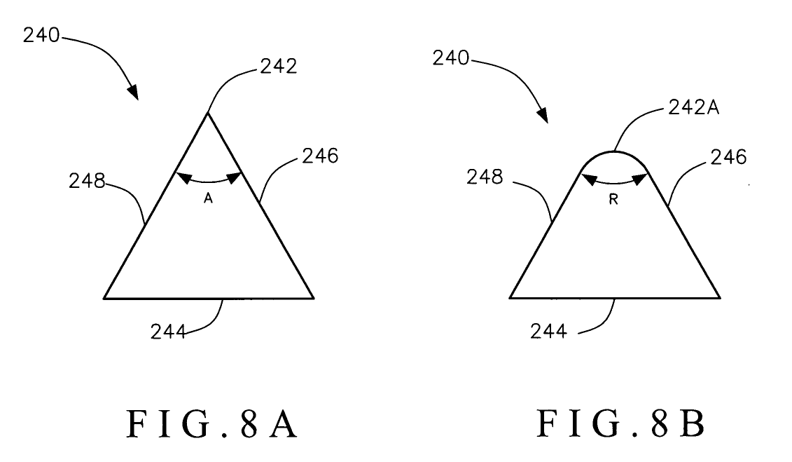

Referring to FIG. 8A, in an embodiment, the long strip prism 240 includes a crest line 242, two inclined surfaces 246, 248 and a bottom 244. The bottom 244 is used as the junction area mentioned above, and the two inclined surfaces 246, 248 extend upward from the opposite sides of the bottom 244 and meet at the crest line 242 to form an intersection angle A. In above embodiments, the intersection angles of two inclined surface in each of the microstructure units 240a, 240b, 240c, . . . or in each of the microstructure units 340a, 340b, 340c, . . . of the same microstructure group 340 are different. Referring to FIG. 8B, in an embodiment, each of the microstructure units 240a, 240b, 240c, . . . has a round angle structure at the crest line of the microstructure units 240a, 240b, 240c, . . . . For example, the crest line 242A of the long strip prism 240 is a round angle structure with a round angle R. As for the illumination performance of the prism 200 or 300, it may be controlled by density on quantity of the microstructure units 240a, 240b, 240c, . . . or 340a, 340b, 340c, . . . and the angle of the two inclined surfaces of the prism 200 or 300.

In summary, the features of the brightness enhancement film in the present embodiments are listed as: the microstructure units have different heights and different intervals between each other rather than only a single extension length and a single extension direction, and the features make the size and direction of the microstructure units irregular, and the intersection angle at crest lines of the microstructure units and the shape at the crest line are used to control illumination as well. The embodiment of the invention has following advantages:

1. When using, there is no pixel moiré phenomenon between the brightness enhancement film and the liquid crystal panel.

2. If two brightness enhancement films are overlapped, there is no pixel moiré phenomenon between the brightness enhancement film and the liquid crystal panel either.

3. The brightness enhancement film has a better elimination effect on optical interference fringe, and when cutting the master slide, the influence of the direction of the microstructure units on the optical interference fringe is not considered. Thus the cutting angle is not limited, so that the utilization of the master slide is increased to further save cost.

The foregoing description of the preferable embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the does not necessarily limit the claim scope to a specific embodiment, and the reference to particularly preferable exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A brightness enhancement film of a backlight module, the brightness enhancement film comprising:
a substrate, having an edge, the edge having an extension direction; and
a plurality of microstructure units, jointed on a surface of the substrate with a plurality of junction areas, the junction areas having different extension directions and different extension lengths, wherein the extension directions and the extension lengths of the junction areas are combined to form a resultant vector, an included angle is formed between the direction of the resultant vector and the extension direction of the edge of the substrate, and a range of the included angle is from negative 45 degree to positive 45 degree.

2. The brightness enhancement film of the backlight module of claim 1, wherein each of the microstructure units is a long strip prism having a crest line and a bottom, the bottom is used as one of the junction areas, and at least one crest height is between the crest line and the bottom.

3. The brightness enhancement film of the backlight module of claim 2, wherein an extension length of the bottom of the long strip prism ranges from 10 um to 10000 um, and the crest height ranges from 0 um to 100 um.

4. The brightness enhancement film of the backlight module of claim 2, wherein the bottom of the long strip prism has at least one width.

5. The brightness enhancement film of the backlight module of claim 4, wherein the at least one width of the bottom of the long strip prism has a maximum value ranging from 10 um to 100 um.

6. The brightness enhancement film of the backlight module of claim 1, wherein each of the microstructure units further comprises a crest line and two inclined surfaces, the two inclined surfaces extend upwards from two opposite sides of the junction area respectively and meet at the crest line to form an intersection angle.

7. The brightness enhancement film of the backlight module of claim 6, wherein the junction area of each of the microstructure units is in the shape of a triangle, a leaf, a rectangle, or a round.

8. The brightness enhancement film of the backlight module of claim 6, wherein the intersection angle of the two inclined surfaces in each of the microstructure units is different from each other.

9. The brightness enhancement film of the backlight module of claim 6, wherein each of the microstructure units has a round angle structure at the crest line.

10. A brightness enhancement film of a backlight module, comprising:
a substrate, having an edge and a plurality of areas, wherein the edge has an extension direction; and
a plurality of microstructure groups, disposed in the different areas of the substrate respectively, each of the microstructure groups comprising a plurality of microstructure units jointed in the same area of the substrate with a plurality of junction areas, the junction areas having different extension directions and different extension lengths, wherein the extension directions and the extension lengths of the junction areas in the same microstructure group are combined to form a resultant vector, an included angle is formed between the direction of the resultant vector and the extension direction of the edge of the substrate, and a range of the included angle is from negative 45 degree to positive 45 degree.

11. The brightness enhancement film of the backlight module of claim 10, wherein the microstructure units in each of the microstructure groups are configured in an arrangement, and the arrangements in the microstructure groups are all the same.

12. The brightness enhancement film of the backlight module of claim 10, wherein each of the microstructure units is a long strip prism having a crest line and a bottom, the bottom is used as one of the junction areas and jointed on a surface of the substrate, and at least one crest height is between the crest line and the bottom.

13. The brightness enhancement film of the backlight module of claim 12, wherein an extension length of the bottom of the long strip prism ranges from 10 um to 10000 um, and the crest height ranges from 0 um to 100 um.

14. The brightness enhancement film of the backlight module of claim 12, wherein the bottom of the long strip prism has at least one width.

15. The brightness enhancement film of the backlight module of claim 14, wherein the at least one width of the bottom of the long strip prism has a maximum value ranging from 10 um to 100 um.

16. The brightness enhancement film of the backlight module of claim 10, wherein each of the microstructure units further comprises a crest line and two inclined surfaces, and the two inclined surfaces extend upwards from two opposite sides of the junction area respectively and meet at the crest line to form an intersection angle.

17. The brightness enhancement film of the backlight module of claim 16, wherein the junction area of each of the microstructure units is in the shape of a triangle, a leaf, a rectangle, or a round.

18. The brightness enhancement film of the backlight module of claim 16, wherein the intersection angle of the two inclined surfaces of each of the microstructure units in the same microstructure group is different from each other.

19. The brightness enhancement film of the backlight module of claim 16, wherein each of the microstructure units has a round angle structure at the crest line.
